(19) United States
(12) Patent Application Publication
(10) Pub. No.: US 2024/0400166 A1
(43) Pub. Date: Dec. 5, 2024

(54) PERSONAL WATERCRAFT

(71) Applicant: Yamaha Motor Corporation, USA, Cypress, CA (US)

(72) Inventors: Brian Johnson, Canton, GA (US); Justin Mitchell, Atlanta, GA (US)

(21) Appl. No.: 18/680,093

(22) Filed: May 31, 2024

Related U.S. Application Data
(60) Provisional application No. 63/506,012, filed on Jun. 2, 2023.

(51) Int. Cl. B63B 34/10; A01K 97/10

(52) U.S. Cl. CPC B63B 34/10; A01K 97/10

(57) ABSTRACT

A watercraft with a hull having an upper side and a bottom side, a seat for a rider located on the upper side of the hull and straddling a centerline of the hull, a steering device movably attached to a fore side of the hull, wherein the steering device controls a speed and direction of movement of the watercraft, a footrest surface where the rider put on a foot that is located on a side of the seat, a gunwale located on the upper side of the hull and side of the footrest, and a rail attached on the gunwale configured to accommodate at least one accessory that has a protruding portion that fits inside of the rail is disclosed. The rail has U shaped opening with flat tops at both ends of the U shape opening configured to accommodate the protruding portion of the accessory. And a kit with the mounting assembly is also disclosed.

### CROSS-REFERENCE TO RELATED APPLICATIONS

This application claims priority to U.S. Provisional Patent Application No. 63/506,012, filed Jun. 2, 2023, the entire contents of which are hereby incorporated by reference herein in their entirety and for all purposes.

### BACKGROUND

A personal watercraft is a popular watercraft mainly used for recreational purposes. A personal watercraft is also called a water scooter or a jet ski. One style of personal watercraft is the runabout of “sit down,” where one or more riders sit on a seat installed on the upper deck of the personal watercraft.

A personal watercraft driver uses a motorcycle-like steering control handle to control the direction and speed of the personal watercraft. A throttle lever attached to the handle controls the rotational speed of an inboard motor that creates water jet thrust for propulsion via a screw-shaped impeller installed in a water channel submerged under water. An angular change of the handle corresponds to an angular change of a steering nozzle that changes the direction of the water jet thrust for turning the propulsion angle of the personal watercraft.

### BRIEF DESCRIPTION OF DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 is a side view of an exemplary personal watercraft.

FIG. 2A is a right side perspective view of a personal watercraft showing gunwale portion.

FIG. 2B is a right side perspective view of a personal watercraft showing gunwale portion with fixing holes.

FIG. 3A is a side perspective of a mount assembly showing an exploded view of various components of an illustrative mount assembly.

FIG. 3B is a bottom perspective of a mount assembly.

FIG. 4A is a partial side perspective of a mount assembly and gunwale of a personal watercraft illustrating the disposal of the mount assembly to the gunwale.

FIG. 4B is a partial side perspective of a mount assembly and gunwale of a personal watercraft illustrating the disposal of the mount assembly to the gunwale.

FIG. 5 is a top partial perspective view of the front part of the mounting assembly.

FIG. 6 is a top left perspective of a central part of the watercraft with rails.

FIG. 7 is a top partial perspective view of the rear part of the mounting assembly.

FIG. 8 is a top partial perspective view of the rear part of the mounting assembly illustrating a middle rail.

FIG. 9 is a front perspective of the left gunwale showing three rails.

FIG. 10 is a top partial perspective view of the rear part of the mounting assembly.

FIG. 11 is a top partial perspective view of the rear part of the mounting assembly illustrating a metal fitting on the gunwale.

FIG. 12A is a bottom perspective of a loop accessory.

FIG. 12B is a partial top perspective illustrating two loop accessory fit in a rail.

FIG. 13 is a top partial perspective view of the rear part of the mounting assembly illustrating a fishing rod holding accessory fit in a rail.

FIG. 14 is a partial side perspective of a personal watercraft with rails directly fit to the gunwale.

### DETAILED DESCRIPTION

Generally described, aspects of the present application relate to accessories or additional features for a personal watercraft. More specifically, in accordance with one or more aspects of the present application correspond to a rail structure that is mountable on the gunwale of at least one side of a personal watercraft. The rail structure is illustratively mounted on the gunwale of a personal watercraft so that at least one of the separate accessory units can be engaged within or outside of groove. In some embodiments, one aspect of the present disclosure illustrates an example of rail structure to form an indentation or unsmooth surface on the gunwale. The existence of rail structure increases friction between the foot or sole of shoes and the watercraft compared to the smooth rounded gunwale. The gunwale may include some form of mat or other surface to avoid foot slippage when the rider sits on the seat facing side for fishing or relaxation purposes.

Aspects of the present application disclosed herein are described below in the context of accessories for personal watercraft. Specifically, in one embodiment, by way of illustration, a personal watercraft can include a personal watercraft with a deck extender accessory, as discussed and described herein. An exemplary disclosure of such personal watercraft is disclosed in United States Patent Application Publication No. US 2021/0371056 A1 (hereinafter referred to as “the 056A1 Disclosure” in this document) and entitled “DECK EXTENDER FOR WATERCRAFT,” which is hereby incorporated by reference in its entirety. However, such personal watercraft configuration is illustrative in nature, and one or more aspects of the present application should not be limited to any particular configuration of personal watercraft, including whether such personal watercraft includes a deck extender accessory or relevant portions of mounting mechanisms may be considered integrated in a personal watercraft.

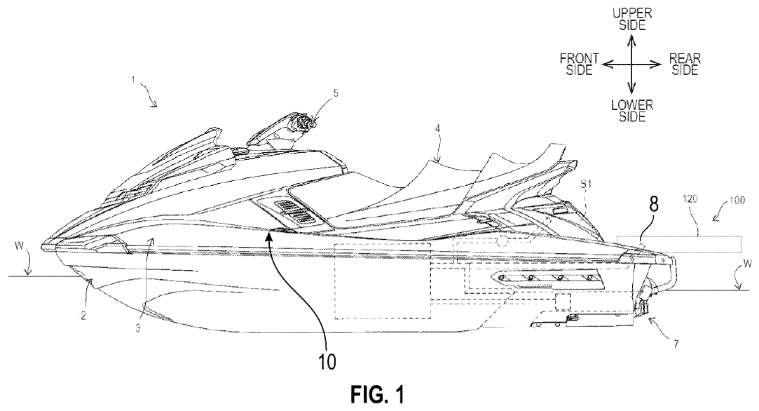

As shown in FIG. 1, the personal watercraft 1 further includes an engine 6 and a jet pump 7. The engine 6 is disposed inside the hull 2. The jet pump 7 is disposed at the rear portion of the hull 2. The engine 6 is disposed forward relative to the jet pump 7. The seat 4 is disposed above the engine 6. Illustratively, the seat 4 is located or disposed on the upper side of the hull 2 and may be further disposed symmetrically along a centerline of the hull 2, which may be characterized as straddling such a centerline of the hull. A steering device 5 movably attached to a fore side of the hull 2. The steering device 5 controls a speed and direction of movement of the watercraft. A footrest surface is where the rider put on a foot is located on both side of the seat.

The deck 3 includes two gunwales 10 in substantial parallel with the centerline of the hull (port and starboard). The outer surfaces of the gunwales 10 may integrated into the side surfaces of the hull 2. Additionally, as illustrated and discussed further, the gunwales 10 have a top surface and an inner side surface to define a channel between a body portion of the personal watercraft 1, where the footrest surface is disposed. a platform 8 disposed at the stern of the personal watercraft 1. The platform 8 slopes gently downwardly, away from the seat 4 and toward the waterline. The jet pump 7 is disposed below the platform 8. The jet pump 7 is driven by the engine 6.

With continued reference to FIG. 1, the personal watercraft 1 is illustrated in a stationary state floating in water, and due to its buoyancy, to a depth shown relative to the waterline. The depth at which the personal watercraft 1 reaches beneath the waterline depends on the total weight and the volume of water displaced by the hull of the personal watercraft 1. As noted above, the platform 8 which forms a rear deck of the personal watercraft 1, slopes gently away from the seat 4 and toward the waterline W. In accordance with some embodiments, the deck extender 100 can be configured such that its upper surface 120 extends generally parallel to the waterline when the personal watercraft 1 is at rest and floating in water. In some embodiments, the upper support surface 120 of the deck extender 100 is not perfectly parallel with the waterline, however, may be closer to parallel with the waterline than the surface of the platform 8. The deck extender includes accessory mounting rails that can be configured for adjustably mounting accessories to the deck member.

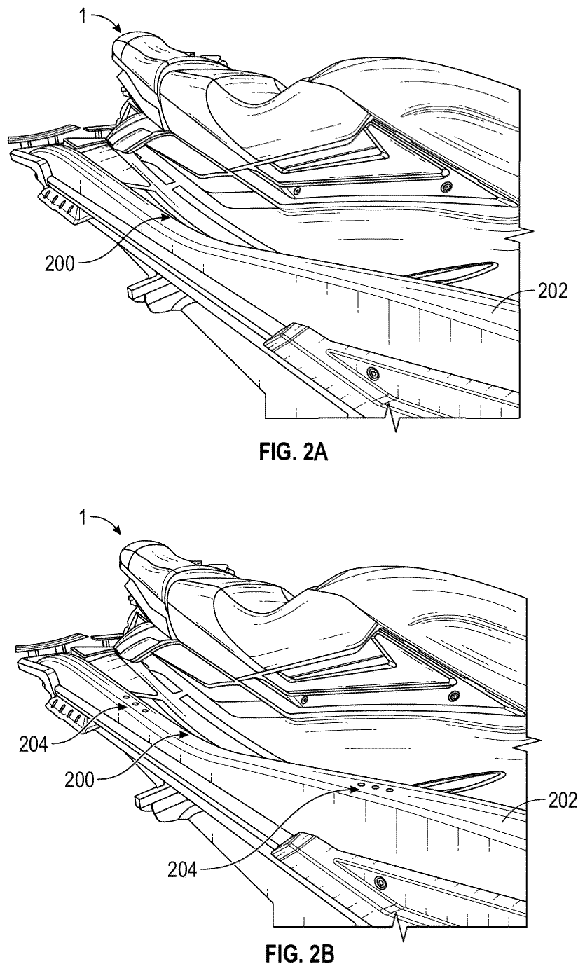

FIG. 2A is an image of a curved gunwale 200 of personal watercraft 1. Illustratively, the gunwale 200 of the personal watercraft is not straight but concaved downwardly and outside in the middle. Illustratively, the top surface 202 of the gunwale 200 can be a rounded top surface with a slight convex center relative to the center of the watercraft. Traditionally, personal watercraft do not include any type of rail system or other mounting systems (as illustrated in FIG. 2A) for the mounting of accessories on the gunwale portions of the personal watercraft 1.

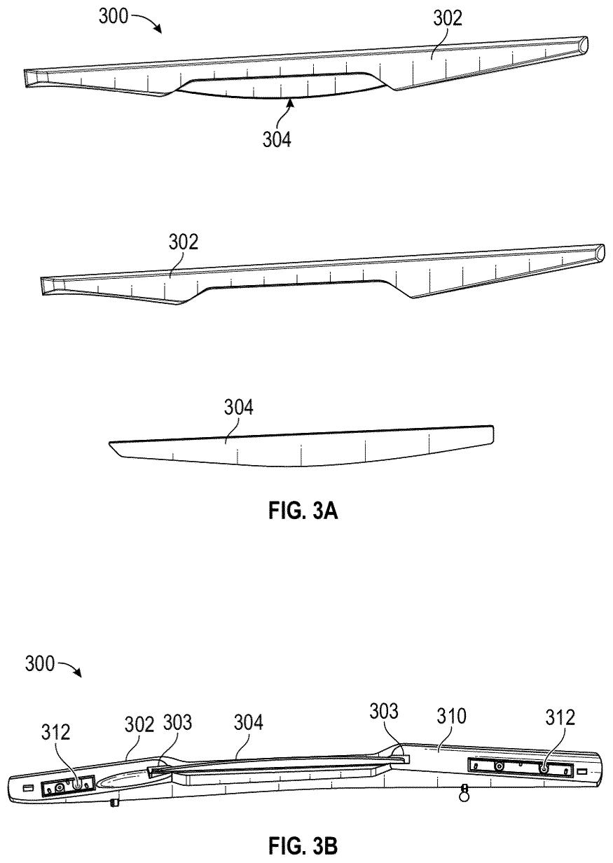

FIG. 2B is a right perspective view of a personal watercraft 1 showing gunwale portion with fixing holes. Illustratively, the gunwale 200 includes a plurality of holes 204 on the top surface 202 of the gunwale 200. Illustratively, the plurality of holes 204 can be configured to fix a mounting assembly 300 (explained below) The hole locations should match with locations of through holes 312 shown in FIG. 3B. Depending on attaching mechanism, the holes 201 may have additional mechanisms such as receiving screws. It should be noted however that no additional mechanisms are needed in the case that blind (pop) rivets 907A, 907B, 907B are used as explained later.

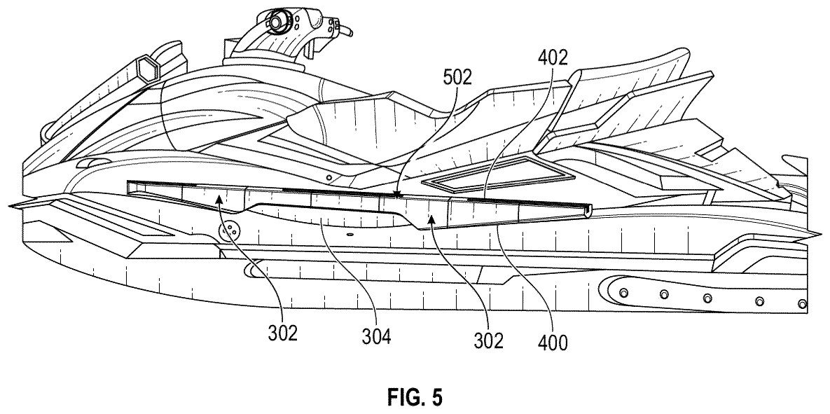

FIGS. 3A and 3B illustrate a mounting assembly 300 for the personal watercraft for use in combination with a rail structure or otherwise having integrated a rail structure according to this disclosure. As will be described in detail below, the rail structure is illustratively formed on the top flat surface of the mounting assembly by fixing rails (as shown in FIGS. 5-9). As illustrated in FIG. 3A, the mounting assembly 300 may include a number of parts/portions that form the mounting assembly. The portions can include a mount body 302 that can be coupled to a mount body window 304 to form the mount assembly 300. It should be noted that a separate mount body window 304 is optional so that one body mount assembly without the mount body window is another embodiment (not shown). The mount assembly 300 may be permanently or semi-permanently attached to a top surface of the gunwale, such as via the fixing holes 201 (FIG. 2B).

The mount body 302 may be made of plastic material through blow mold, injection mold, compression mold, 3D printing or any other known process. In some applications, formation of the mount body 302 through molding may have some advantages to creating a cavity structure of the mount body (empty inside) to reduce weight and amount of material and simplify the process of tooling and production time. Illustratively, a bottom surface 310 the mount body 302 can have a curved structure complimentary at least a portion of the curved surface of the gunwale. Specifically, the bottom surface 310 may be manufactured to match the curvature of the rounded top surface of the gunwale to fit the personal watercraft. As further discussed below, the shape of the mount body 302 may configured such that a top surface of the mount body 302 can present one or more surfaces for a rail system. The top surface of the mount body 302 (after mounting to a gunwale) can be relatively parallel to the rail system. The top surface of the mount body 302 may be substantially horizontal in some embodiments (relative to the waterline). The top surface of the mount body 302 may be angled relative to fore or aft of the personal watercraft such that at least a portion of the rail system is angled. Still further, in some embodiments the mount body 302 may be further angled vertically such that an integrated rail system projects outwardly toward the personal watercraft, outwardly away from the personal watercraft, and the like.

The mount assembly 300 further includes a window portion 304 that may be coupled to the mount body 302. In this embodiment, however, the window portion 304 is pressure fit in the slots 303 formed in the middle of the mount body 302 as shown. Therefore, the window portion 304 is securely set at a right position when the mount body 302 is fixed to the watercraft body.

FIG. 3B is a bottom perspective of a mount assembly 300 in accordance with illustrative embodiments. As illustrated in FIG. 3B, the bottom surface 310 of the mounting body 302 has through holes shown 312 (two of each on the right and left sides in FIG. 3B) to fix it to the watercraft body with fixing screws (not shown), rivets, or the like. The mount body 302 can be one part or a combination of several portions. The window part is made of a transparent plastic plate such as polycarbonate. The thickness is decided to fit in a slot created on the backside of the mold body, as seen. They can be glued with adhesive as an embodiment. However, it may not need to do so in the case that it snuggly fits the mount body with adequate tolerance.

After fixing the mount body 302 to the watercraft body via screws, rivets, glue, adhesives, or a similar attaching device (strong enough to hold the mounting body to the gunwale securely), the window portion 304 may be coupled to the mount body 302 firmly supports the pressure from the top of the mount body. In this embodiment, however, the window portion 304 is pressure fit in the slots 303 formed in the middle of the mount body 302 as shown. Therefore, the window portion 304 is securely set at a right position when the mount body 302 is fixed to the watercraft body. As will be explained below, the window portion 304 may be constructed and mounted in a manner such that a bottom surface of the window portion does not contact the top surface of the gunwale. In this embodiment, a gap may be formed between the bottom surface of the window portion and the top surface of the gunwale to allow for the flow of water within the formed gap.

The window portion 304 can be opaque as well. A transparent or semi-transparent window portion 304 is suitable for looking outside from the watercraft rider and for looking into the watercraft from outside through the part. As another embodiment, the shape of the window part may create a little gap near the lowest point (near the most right bottom portion in the figure) between the gunwale top surface so as to release water through the gap. A transparency window part attached to the mounting assembly can create a positive cosmetic impact on the consumer so that the company logo or other trademark may be attached to the portion.

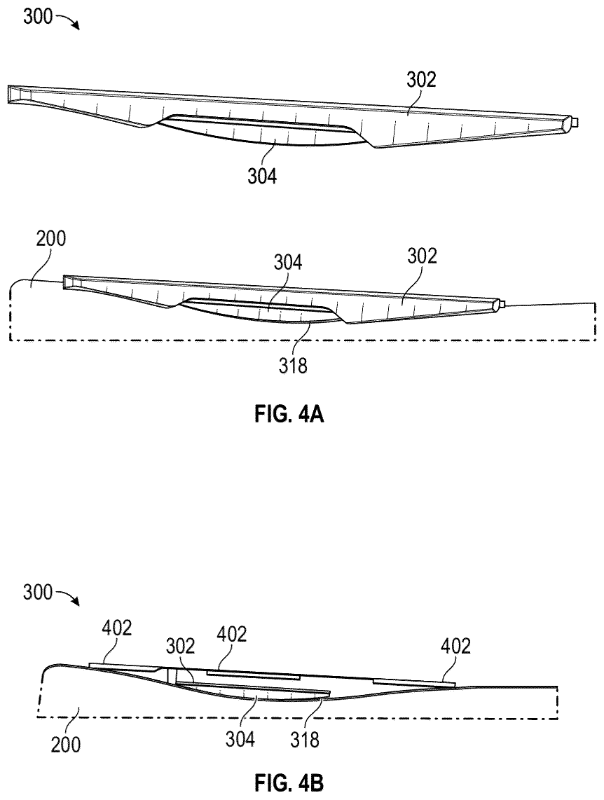

FIGS. 4A and 4B are partial side perspectives of a mount assembly and gunwale of a personal watercraft illustrating the disposal of the mount assembly to the gunwale. FIGS. 4A and 4B further illustrate how the mounting assembly 302 fits the rounded top surface of the gunwale 200 of the watercraft 1. With reference to FIG. 4A, the window portion 304 is complimentary in shape to the gunwale top surface 400, but may have a gap 318 as described above.

With reference to FIG. 4B, the mount body 302 can present a plurality of rails 402 on the top surface as described herein. Illustratively, the plurality of rails 402 provide a mounting mechanism for affixing a variety of components, such as accessories, to the personal watercraft. Although a number of illustrative examples of mounting accessories will be described for purposes of illustration, one skilled in the relevant art will appreciate that such examples are illustrative in nature. Still further, in some embodiments, the plurality of rails include three distinct rail portions (or sub-portions). However, the number of subdivisions of rails in conjunction with the mounting assembly is not limited to the disclosed embodiments.

FIG. 5 illustrates a side view of one of the embodiments of a personal watercraft with the mounting assembly 300 attached. In this illustrative embodiment, a top surface 502 of the mounting assembly 302 creates a top surface (desirably substantially horizontal relative to the personal watercraft at rest) over the rounded gunwale 402 of the watercraft body. The top surface 502 is suitable to fix the rail structure 402 with its flat bottom. Illustratively, the top surface 502 of the mounting assembly 302 may be considered relatively flat or horizontal, such that the mounting of accessories to the rails 402 (FIG. 4B) presents a substantially horizontal mounting surface. In other embodiments, the top surface 502 may be angled in a manner such that any accessories mounted on the rails would also be angled relative to a horizontal plane of the personal watercraft 1. In one example, the top surface 502 may be angled inward (relative to the body portion of the personal watercraft 1, such as in the range of 0 degrees to 45 degrees (including all intervening intervals). In this example, the inward angle of the mounting surface can provide greater access to accessories from a user on the seat of the personal watercraft 1. In one example, the top surface 502 may be angled outward (relative to the body portion of the personal watercraft 1, such as in the range of 0 degrees to 45 degrees (including all intervening intervals). In this example, the outward angle of the mounting surface can provide less interface between accessories on the rails 402 and a user on the seat of the personal watercraft 1. Still further, in some examples, the various rail components 402 may have different angles of inclination (e.g., inward angle, outward angle, horizontal) to accommodate for different types of accessories or uses.

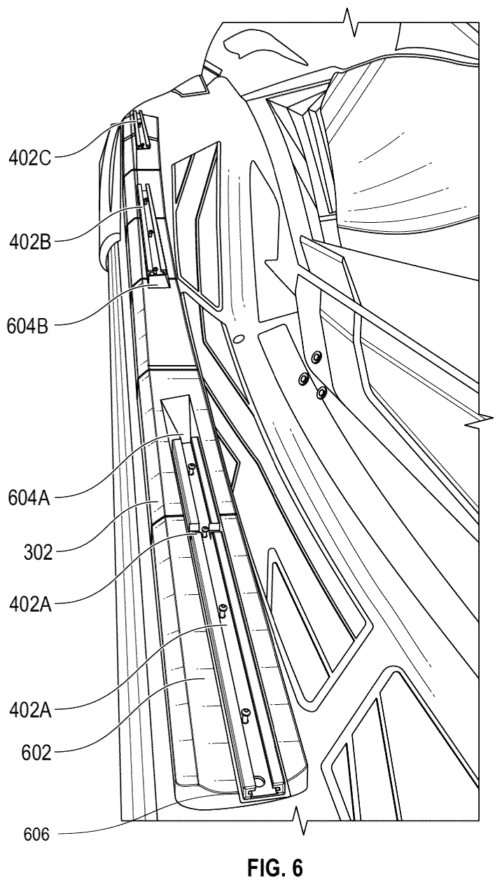

FIG. 6 illustrates a partial perspective view of one of the embodiments according to this disclosure from a rear side. The gunwale is located next the left footrest area that is adjacent to the seat as shown. The mounting assembly 300 is attached to the watercraft 1, more specifically on the top of the gunwale. A groove or track is formed 901 (shown in FIG. 100) on the top of the mount body 302. A set of rails are mounted on the top surface 602 of the mount body 302. Specifically, in this embodiment, the top surface 602 of the mount body 302 includes a plurality of grooves 604 or track (recess portions created on the top surface 602 of the mount body 302) with fixing screws. The rail is installed in a recessed portion that securely fix the rail and top of side walls of the recessed portion is close to a height of the rail so as not to create gap between the top of the side walls and a top side of the rail.

In some embodiments, the top surface 602 includes multiple groove structures 604 associated with the front, middle and rear portions of the mount assembly 300. Illustratively, rails 402 (rear rail 402A, middle rail 402B, and front rail402C) may be generally referred to as a “sub rail” or rail sub-components are attached on each surface of the grooves 604 and form a rail system as a whole. In some embodiments, the rails may be configured or disposed such that the rails 402A, 402B, 402C are collinear. In other embodiments, the rails may be configured such that at least two are non-collinear. Three separate rails (in this embodiment) can create a flexibility of angular orientations in three dimensions and relative locations of each rail according to the designer's intention. For example, one rail can be projected outwardly toward the personal watercraft, and other rail can be projected outwardly away from the personal watercraft.

With reference to FIG. 6, a rear groove 604A starts from the upper rear end of the mount body, and it is longer than the rail 402A installed with a slope on the front side to accommodate accessory parts from both sides of the rail. The slope assists in accommodating a protruding portion of an accessory, making it easier to slide inside the U-shaped rail opening. The angle of the slope can be 10 to 45 degrees (preferably 25 degrees) angle depending on the accessory's bottom shape design. The smaller the angle of the slope, the longer the slope become, which makes the maximum length of the rails shorter due to the limited length of usable gunwale size.

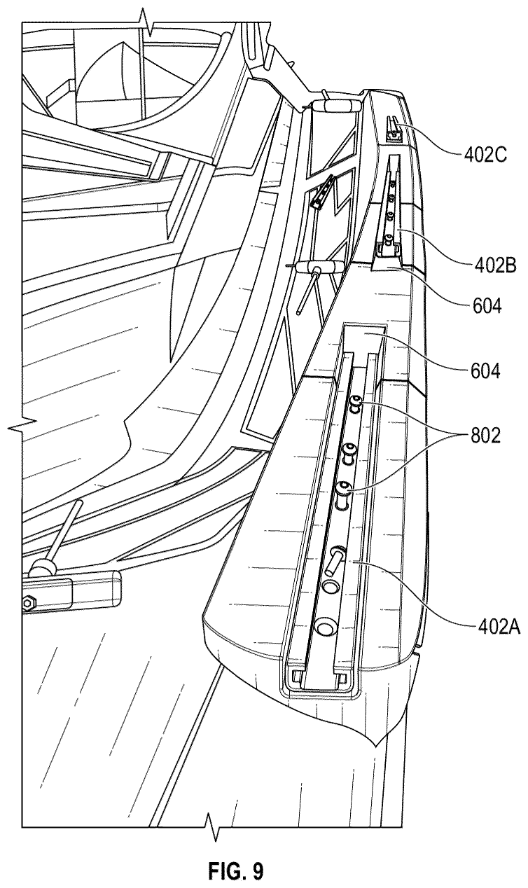

The middle groove 604B is located in the middle of the mount body 302, and it is longer than the rail 402B installed, with slopes on both sides on the front side so as to accommodate accessory parts from both sides of the rail. The front groove starts from the upper front end of the mount body, and it is longer than the rail 402C installed with a slope on the rear side so as to accommodate accessory parts from both sides of the rail. As the rails are fixed to the flat surface of the groove, the top surface of the rail and the side walls of the grove 606 is aligned so as not to create major gap. Some examples of accessory parts will be illustratively shown later. It should be noted that the three rails 402A, 402B, and 402C are not inline due to the slight convex curvature of the gunwale design in this embodiment. The rails 402 may be made of aluminum, stainless steel or other rust-free material with the same dimension and configuration disclosed in the 056A1 disclosure (especially accessory mounting rails 165 in FIGS. 9A and 9B; paragraph [0099].)

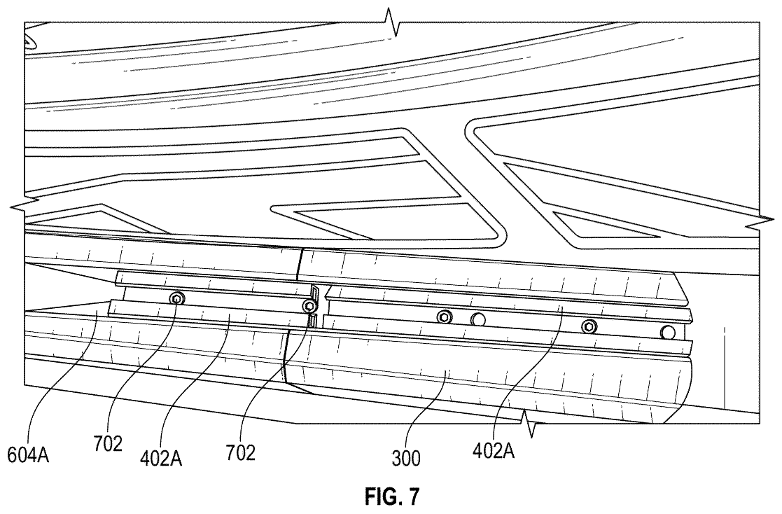

FIG. 7 illustrates a top partial perspective view of the mounting assembly 300 according to illustrative embodiments. The image of the rail 402A mounted in the groove of the mount body and its layout relative to the groove 604 can be seen more closely. There are four screws 702 that securely tighten the rail 402A to the groove 604A formed within the top surface of the mounting assembly 300. All screws are engaged to fasten the rail to the mount body after installation securely.

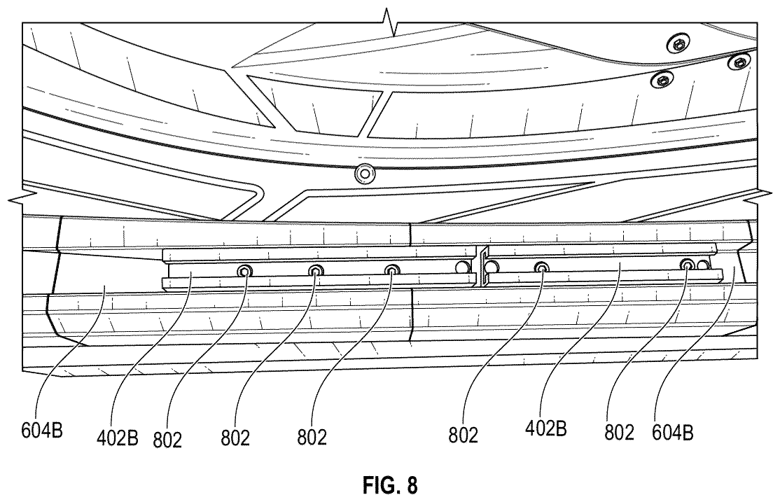

FIG. 8 illustrates a top partial perspective view of the middle part of the mounting assembly 300 according to illustrative embodiments. The image of the rail 402B mounted in the groove 604B of the mount body and its layout relative to the groove 604B can be seen more closely. Illustratively, a set of screws 802 may be utilized to fasten the rails (permanently or semi-permanently) to the mounting assembly 300 (FIG. 3B). All screws 802 are engaged to fasten the rail to the mount body after installation securely. A similar structure is also utilized in the front part of the mounting assembly.

FIG. 9 illustrates a top partial perspective view of of the mounting assembly 300 according to this embodiment. The image of the rail 402A mounted in the groove of the mount body and its layout relative to the groove 604 can be seen more closely. There are four screws shown and they are loosely fit or disengaged for explanatory purposes. All screws 802 are engaged to securely fasten the rail to the mount body after the complete installation. This figure shows slight curvature of the top surface of the mounting assembly that follows the shape of the gunwale of the personal watercraft in this embodiment.

The rail structure can be divided into three or more rails such as 402A, 402B and 402C, as illustratively shown in this embodiment. It will be easier to have a combination of shorter rails for attaching accessory units to the gunwales as the distance between the final fixing location of the unit and the initial entry location (through the end of a slope in the groove of the mounting assembly) become shorter. This shorter rail approach is particularly advantageous to position the rail close to the middle of the top surface of the curved mounting assembly. Each rail 402A, 402B and 402C can be installed in the tangential line of the curvature to stay in the middle of the top surface of the mounting assembly 300. In other words, there is no need to locate the end of the rail to either the right or left edge of the gunwale to make a longer rail to be positioned on the mount assembly 300.

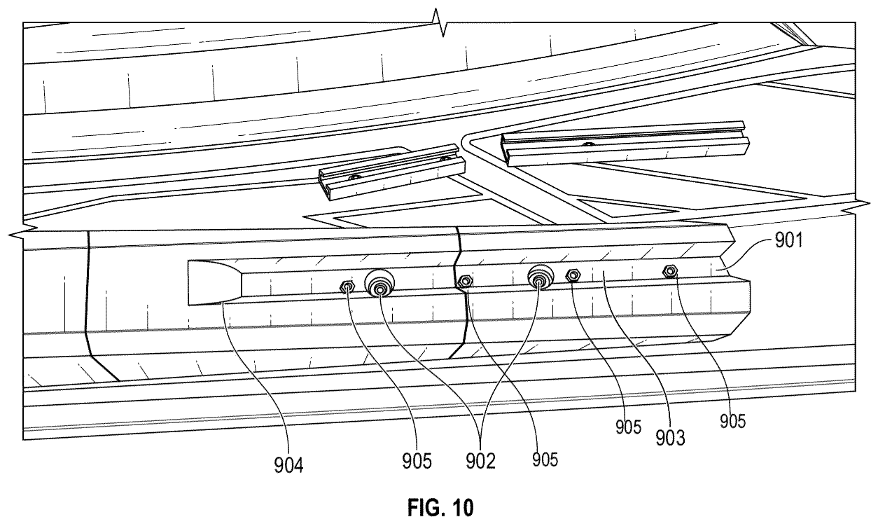

FIG. 10 illustrates a top partial perspective view of the rear part of the mounting assembly 300 according to this embodiment. The four screws and a rail securely fastened to the mounting assembly are all removed to see the structure underneath them. As illustrated in this figure, there are two larger round openings 902 with metal screw heads and four smaller nuts with screw holes 905. The larger opening 902 is a larger cylindrical hole of stepped holes. A screw (not shown) goes through the stepped holes 902 and engages with a metal fitting 906 with nuts 905 attached to the personal watercraft body (shown later.) The rail shown is cut in half in this embodiment; however, it can be a single rail.

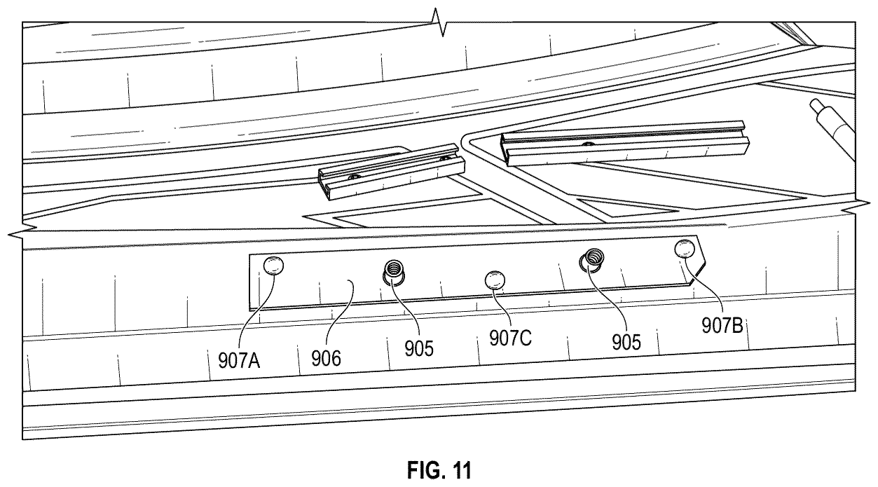

FIG. 11 illustrates a top partial perspective view of the rear part of the watercraft according to an embodiment. The metal fitting 906 with nuts 905 to accommodate the screws through the mount body is shown. The metal fitting 906 is securely fixed via three blind (pop) rivets 907A, 907B and 907C at the vicinity of the two top corners and lower middle position. The corresponding through holes 201 are illustratively shown on FIG. 2B. The corresponding part of the metal fittings 906 with the rivets 907A, 907B, 907C are shown on the right and left sides of the bottom figures in FIG. 3B. The metal fittings and the rivets are some of the other small parts within the mounting assembly 300. Illustratively, holes in the gunwale 10 may be included as part of the manufacturing process, which can include additional components for receiving bolts, etc.

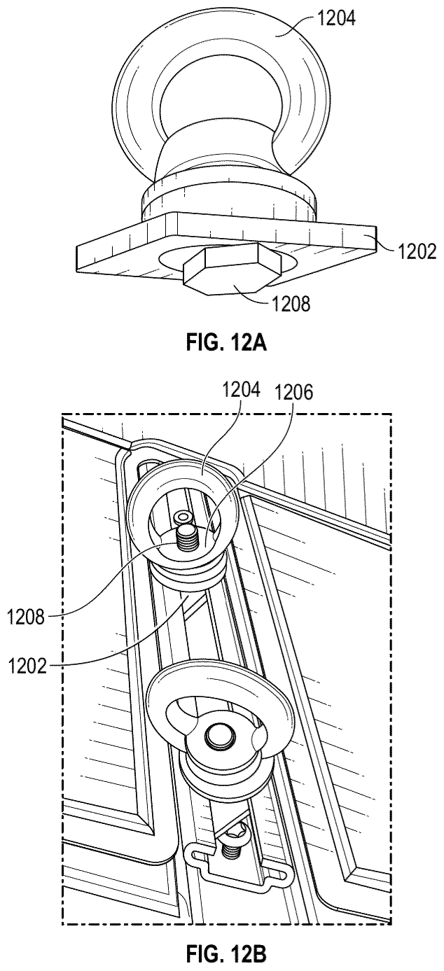

FIGS. 12A and 12B illustrate one example of accessory units. A rectangular stopper plate 1202 slots that is protruding from the center of the accessory unit that engages with upper portion of the rail when it is installed in the rail. And the semicircular portion 1204 is tightly secured by twisting the upper semicircular portion 1204. It holds any hook or carabiner that is part of or connected with another accessory. A female screw hole 1206 formed under the semicircular part engages with a bolt 1208 to adjust the relative distance of the rectangular stopper plate. Still further, in some embodiment, accessory units in the shape of plate or additional planar surface can be attached to the rails to provide for additional surface areas. Such surface areas may be used to mount equipment on the personal watercraft.

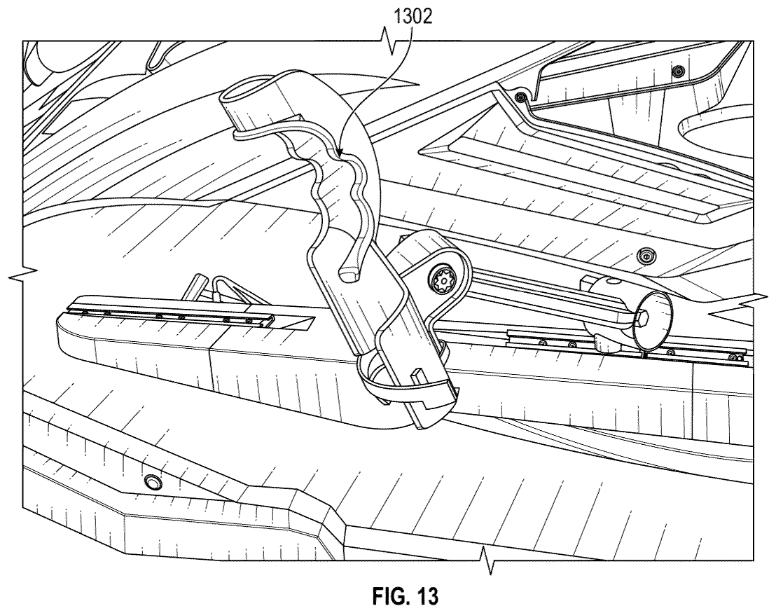

FIG. 13 illustrates an embodiment of an accessory unit for securing items to the rail on the gunwale. It is a fishing rod holder 1302 to be secured to the rail. The base portion includes a swiveling mechanism to change the rotational angle of the holder 360 degrees with the nut and screw combination. The holder includes two joints that also can change the position of the grip and the angle of the rod, respectively. With this fishing rod holder 1302, the watercraft rider can enjoy fishing on the water while sitting on the seat forwardly or sideways.

Another embodiment is to form grooves and slopes similar to the ones created on the top surface of the mounting assembly. While the above embodiments utilize the mounting assembly to attach the rails to the gunwale of watercraft, it is not the prerequisite for attaching rail structure according to this disclosure. In some embodiment, portions of the rails and mounting assembly described above may be directly integrated into the gunwale of a personal watercraft. Similar shape of grooves and slopes as the mounting assembly are formed on the gunwale of the personal watercraft together with necessary fixing mechanism such as screw or rivets holes to attach the rails. In this embodiment, a separate mounting assembly can be omitted. The mounting assembly is necessary to create a flat surface for fixing the rails. Therefore, the mounting assembly is necessary for the watercraft with a gunwale having a round top surface, even if there is no curvature in longitudinal direction with the gunwale. There is no need to have amounting assembly in the case the gunwale top has a flat surface and slopes as explained in connection with the mounting assembly. Illustratively, the gunwale is rather straight and has a flat surface that is wider than the width of the rail, the rail can be attached to the gunwale, such as through grooves or if the rail system is manufactured in the gunwale. As discussed with regard other examples, it is easier to install the rails and accommodate various types of accessories (such as a fishing rod holder, boat fenders, etc.) to be attached to the rails.

As described in the above embodiment, the mount assembly, consisting of one or more rails, a mount body, a fixing device (as well as a mount body window), can be assembled as a kit that is available for separate purchase. This kit is particularly advantageous for aftermarket applications, offering additional functionality for attaching accessories to a gunwale. The kit can be adjusted to fit various existing watercraft models by modifying the size and curvature of each model's gunwale. Utilizing a 3D printer is suitable for smaller-scale production of customized mount bodies and mount assembly kits.

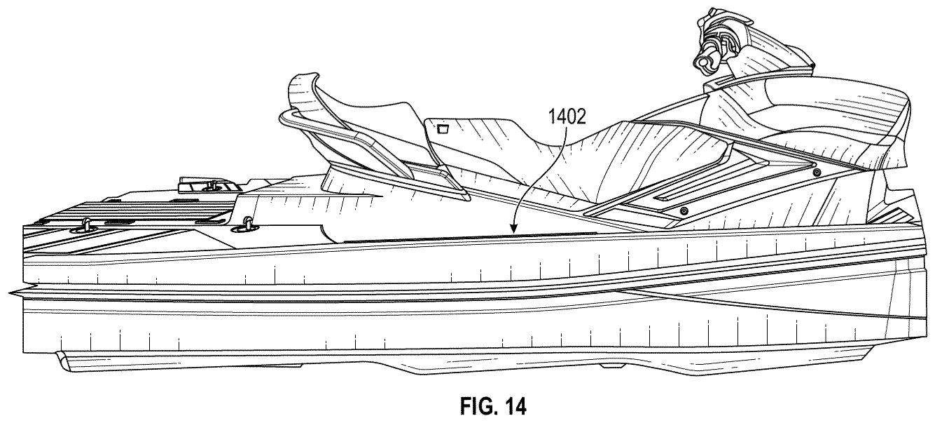

FIG. 14 shows another embodiment of present disclosure that can use an edgeless rail structure to fix the rail 1402 (aggregately illustratively shown in a thick black line) to a flat surface of the gunwale. Same as previously described embodiment, one or more rails can be installed recessed portion (a groove or track) of the gunwale so that the rail(s) does not interfere the user of the watercraft. Both ends of the rail can be sloped or rounded to accommodate the accessory smoothly. And the longitudinal side walls of the rail can be formed with sloped or rounded shape to fit with the flat surface of the gunwale. In this embodiment, the rail structure 1402 is covered by a rail cover with preferably with rubber material, plastic or other flexible material with the same color of the gunwale that slot into the rail via slop portion of the groove or track of the rail structure, so that entire recessed portion is completely covered by the rail cover part. The rail cover has striped grooves or protrusions on the upper surface in the longitudinal direction to increase friction. However, another embodiment can use another patterned surface with checker flag type indentations or sandpaper like surface pattern to increase friction. The rail cover part will function as an anti-slippage footrest for the rider who sits on the seat and put foots on the gunwale. The upper portion of the rail cover has a lower portion underneath the upper surface of the rail cover, which has a continuous or partial stopper portion that can engage with the lower side of the top portion of the rail that securely engage the rail cover to the rail structure. The cross section of the top cover can be a T shaped with a triangular vertical stopper portion. The bottom of the triangular vertical stopper portion can touch the bottom portion of the U-shaped rail when the top of the rail cover is pushed downwardly. Another embodiment can be just indentations on both sides of the vertical stopper portion that fit with the upper portion of the U-shaped rail. An attached flexible rail cover can be removed by pulling one end from the slop portion of the groove or track, then various kind of accessory can be attached to the rail as needed. The rail cover enhances cosmetic image of the gunwale surface and also increase the friction of the gunwale. It should be noted that the cover of the rail can be flexible for considering the easiness of installation and removal. However, it can be made of a rigid material factoring in the tolerance and gap with the rail.

Another embodiment of present disclosure can also create the rail structure on both sides of the watercraft. The capability of supporting accessories on both gunwales can provide flexibility to choose the position of the accessory relative to the watercraft. And also, the symmetrical rail system is capable of supporting trailing hitch parts or canopy-supporting polls with adequate accessory design.

Although the embodiments of the present application have been described above, the embodiment is presented as an example and is not intended to limit the scope of the present application. Such a novel embodiment can be implemented in various other forms and can be omitted, replaced, and changed without departing from the gist of the invention. The embodiment and its modifications are included in the scope and gist of the aspects of the application.

What is claimed:

1. A watercraft, comprising:
a hull having an upper side and a bottom side;
a seat located on the upper side of the hull and straddling a centerline of the hull;
a steering device movably attached to a fore side of the hull, wherein the steering device controls a speed and direction of movement of the watercraft;
a plurality of gunwales, wherein each gunwale in the plurality of gunwales is located on the upper side of the hull and side of the seat; and
a rail attached on the gunwale configured to accommodate at least one accessory that has a protruding portion that fits inside of the rail;
wherein the rail has U shaped opening with flat tops at both ends of the U shape opening configured to accommodate the protruding portion of the accessory.

2. The watercraft of claim 1, wherein the rail is detachable attached to the gunwale with screws.

3. The watercraft of claim 1, wherein the rail is consisting of a plurality of separate sub rails.

4. The watercraft of claim 3, wherein the sub rails are at least one of collinear or non-collinear.

5. The watercraft of claim 1, further comprising a mount assembly that has a lower side configured to fit to an upper side of the gunwale and an upper side including at least one flat surface to accommodate the rail.

6. The watercraft of claim 1, wherein the rail is installed in a recessed portion that securely fix the rail and top of side walls of the recessed portion is close to a height of the rail so as not to create gap between the top of the side walls and a top side of the rail.

7. The watercraft of claim 6, wherein the recessed portion has at least one slope configured to slide in the protruding portion of the accessory into a U shaped opening of the rail.

8. The watercraft of claim 6, wherein the recessed portion is formed on a top surface of the gunwale.

9. The watercraft of claim 1, further comprising a rail cover fits on and cover the rail.

10. The watercraft of claim 6, wherein the recessed portion is formed on a top of a mount assembly that has a lower side configured to fit to an upper side of the gunwale and an upper side that securely fix the rail.

11. A rail kit for a personal watercraft, comprising:
a mount assembly that has a lower side and an upper side, wherein the lower side fits to an upper side of a gunwale of the personal watercraft and wherein the upper side including at least one flat surface;
a rail configured to be fixed to the flat surface of the mount assembly; and
a fixing device for securely fixing the rail to the flat surface.

12. The rail kit for a personal watercraft of claim 11, wherein the mount assembly is made of plastic material.

13. The rail kit for a personal watercraft of claim 11, wherein the mount assembly further includes a mount body and a mount body window, wherein the mount body supports the rail.

14. The rail kit for a personal watercraft of claim 13, further include a rail cover that fits the rail to cover a top of the rail.

15. The rail kit for a personal watercraft of claim 14, wherein the rail cover is made of rubber, plastic or other flexible material.

16. The rail kit for a personal watercraft of claim 13, wherein the mount assembly includes a mount body that is made of opaque material, and a mount body window that is made of transparent material.

17. The rail kit for a personal watercraft of claim 13, wherein the mount body window creates a gap with the gunwale.

18. A watercraft, comprising:
a hull having an upper side and a bottom side;
a plurality of gunwales, wherein each gunwale in the plurality of gunwales is located on the upper side of the hull and side of a seat; and
a rail attached on the gunwale configured to accommodate at least one accessory that has a protruding portion that fits inside of the rail; and
wherein the rail has U shaped opening with flat tops at both ends of the U shape opening configured to accommodate the protruding portion of the accessory.

19. The watercraft of claim 18 further comprising a mount assembly that has a lower side and an upper side, wherein the lower side fits to an upper side of a gunwale of the watercraft and wherein the upper side including at least one flat surface, wherein the rail configured to be fixed to the flat surface of the mount assembly.

20. The watercraft of claim 18, wherein the rail is angled relative to the watercraft.
